(19) United States
(12) Patent Application Publication
(10) Pub. No.: US 2004/0231709 A1
(43) Pub. Date: Nov. 25, 2004

(54) Method of inspecting concrete surface and method of repairing same

(76) Inventor: Shin Narui, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/880,487

(22) Filed: Jul. 1, 2004

(30) Foreign Application Priority Data
Dec. 13, 2001 (JP) 2001-380574

(51) Int. Cl. B08B 7/04

(52) U.S. Cl. 134/37; 134/34; 134/42

(57) ABSTRACT

A method of inspecting a concrete surface. The method comprises ejecting highly pressurized water to a concrete surface by using a jet nozzle, thereby fracturing and spalling off deteriorated concrete deteriorated in strength, with leaving only sound concrete, for inspection of surface strength.

### CROSS-REFERENCE TO RELATED APPLICATIONS

The present application claims priority upon Japanese Patent Application No. 2001-380574 filed on Dec. 13, 2001, which is herein incorporated by reference.

### BACKGROUND OF THE INVENTION

1. Field of the Invention

The present invention relates to a method of inspecting a concrete surface and a method of repairing concrete.

2. Description of the Related Art

In recent years, there have frequently occurred accidents in which concrete structures such as bridges, tunnels, expressways, railroads for the Shinkansen, and harbor structures have deteriorated, and concrete fragments spall and fall from the surfaces of the concrete structures.

FIG. 10A shows a sectional view of a deteriorated concrete structure 1. The concrete structure 1, at its surface S, is in contact with an external environment such as air or sea water, and includes therein a reinforcing bar (rebar) 2a in a position at a depth Dᵣ.

Since concrete, even in a sound state, has a fine pore structure, a large number of capillary pores are exposed on the surface S. Meanwhile, those surrounding the concrete structure 1, such as acid rain, carbon dioxide, chloride ion (Cl⁻), and freezing/melting (through which water freezes and expands), are media for accelerating deterioration of concrete and reinforcing steel. When these media penetrate into concrete through pores and diffuse inside the concrete, chemical reactions proceed inside to gradually neutralize an alkaline concrete composition, resulting in reinforcing steel becoming likely to corrode. Moreover, when the chemical reaction with carbon dioxide further proceeds, the so-called carbonation (neutralization) occurs, where the hardening material composition of cement itself in the concrete is decomposed.

Referring to FIG. 10A, deteriorated concrete 1a with degraded strength due to such neutralization and carbonation is formed between the surface S and an interface B. Moreover, red rust 3 occurs around the rebar 2a to cause volume expansion (about 2.6 times), resulting in cracks 4 occurring in the concrete around the rebar 2a. The cracks 4 promote the penetration of the deterioration accelerating media, causing the deterioration to accelerate. When the cracks 4 further grow and become cracking on the surface, the integrity of concrete will be lost to allow a concrete fragment 1c to detach itself in the end.

The spallation of a concrete fragment normally occurs without any warning. If spallation occurs while a vehicle, train, human or the like is passing by a concrete structure, there is a great possibility that a large-scale accident may be caused. Therefore, in order to prevent accidents, countermeasures have been required, where an inspection for deterioration is regularly carried out and a portion having a good possibility of spalling due to grown cracking is immediately repaired.

However, the depth D_{B} of the deteriorated concrete 1a depends on environments and therefore varies with positions even in the same structure, making the interface B irregular as shown in the drawing. An exact depth of the deteriorated concrete 1a is difficult to tell.

As the inspection for surface deterioration of a concrete structure, two types of inspection have been conventionally performed: a visual inspection to visually check cracking and the like, and a tapping test using a hammer to survey the state of inner deterioration. In the latter, an inspector taps the surface of a structure being inspected with a hammer, listens to the tapping sounds, and determines the presence of deteriorations in the concrete, such as pop-out, cracking, and inner corrosion. Sound concrete may have integrity as a structure and therefore may produce a tapping sound varying little with positions, as well as being a relatively bass sound. In a deteriorated portion, on the other hand, since the integrity and stiffness as a structure are degraded, a different sound from that of a healthy portion is heard.

A deteriorated portion found through this inspection/test is marked and forcibly spalled off by repeatedly tapping with a hammer. Thereafter, the concrete is repaired on the surface side with repair concrete 5 as shown in FIG. 10B. Alternatively, the concrete is reinforced with a steel plate or is subjected to treatment for preventing spallation by using glass fiber and an adhesive.

However, there has been a problem that the reliability of the tapping test as described above is poor because ways of tapping differ among individual workers, and because the acceptance standard is organoleptic and largely depends on the subjectivity of a worker.

Accordingly, the test process becomes stricter, which leads a worker to tap concrete more times than is appropriate. As a result, there has been a problem that such tapping may be counterproductive in some cases because of adversely accelerating deterioration or even causing a sound portion to deteriorate. In contrast, there also has been a problem that, as a result of fear of tapping too much, concrete is repaired with the deteriorated concrete 1a still left as shown in FIG. 10B, resulting in repair effect not lasting long.

Further, there has been a problem that test costs are enormous because the test has to be done, while taking a long time, by a small number of skilled workers who have mastered the work.

### SUMMARY OF THE INVENTION

The present invention was made in view of the problems as described above, and an object thereof is to propose an objective and reproducible method of inspecting a concrete surface, which does not cause a sound portion of a structure to be inspected to deteriorate even after inspection.

Another object of the present invention is to propose a method of inspecting a concrete surface, which makes it possible to reduce the number of inspectors by mechanization of inspection work.

Still another object of the present invention is to propose a rational and highly reliable method of repairing concrete, which takes advantage of such methods of inspecting a concrete surface.

In order to solve any of the problems stated above, according to one aspect of the invention, a method of inspecting a concrete surface, the method comprising ejecting highly pressurized water to a concrete surface by using a jet nozzle, thereby fracturing and spalling off deteriorated concrete deteriorated in strength, with leaving only sound concrete, for inspection of surface strength.

Accordingly, the concrete is fractured by a jet stream of highly pressurized water permeating through a pore structure and cracks in the deteriorated concrete thereby advancing breakage. Therefore, the sound concrete having no such faults will not be broken.

According to another aspect of the invention, in the above method of inspecting a concrete surface, the concrete surface is swept by a water jet while ejection conditions for ejecting the highly pressurized water and a standoff distance are kept constant, the standoff distance being a distance between the jet nozzle and the concrete surface.

Accordingly, conditions for concrete fracture are kept constant by maintaining the constant conditions of discharging the highly pressurized water and the constant standoff distance. Therefore, it is possible to preserve the reproducibility of inspection conditions, and to fracture and spall off the concrete which is determined to be deteriorated concrete under such objective inspection conditions.

In addition, since the concrete surface is swept by the water jet in a manner as described above, the inspection can be performed without omission.

According to yet another aspect of the invention, in the above method of inspecting a concrete surface, the standoff distance is set so that a high-pressure water jet to be ejected to the concrete surface is in a continuous stream region located downstream of a transition zone.

Accordingly, since the jet stream region where impact pressure and fluctuation thereof markedly occur is adopted for the high-pressure water jet, the high-pressure water jet permeates through a pore structure and cracking portions in the concrete, which are faults in a concrete composition, and accelerates breakage from the faults to fracture the concrete. Thus, the sound concrete can be left reliably.

According to still another aspect of the invention, in the foregoing method of inspecting a concrete surface, conditions of the high-pressure water jet are set to be in ranges of ejection water pressure of 50 to 80 MPa; ejection water amount of 20 to 50 liter/min; and nondimensional standoff distance of 100 to 500, the nondimensional standoff distance being obtained by dividing the standoff distance by an orifice diameter d of the jet nozzle.

According to the conditions set as described above, it is possible to allow the continuous stream region of the high-pressure water jet to hit the concrete surface. Therefore, it is possible to easily obtain a suitable high-pressure water jet for use in the method of inspecting a deteriorated concrete surface.

According to yet another aspect of the invention, in the above method of inspecting a concrete surface, the jet nozzle is used in a manner that the jet nozzle is put into rotational motion and thereby causes the high-pressure water jet to draw a conical orbit.

Accordingly, it is possible to eject the water jet over a wide area while suitably maintaining the properties of the high-pressure water jet. Therefore, sweeping work is facilitated, and an inspection without omission becomes feasible.

According to still another aspect of the invention, in the above method of inspecting a concrete surface, the concrete surface to undergo the surface inspection and an ejecting section for ejecting the highly pressurized water are both covered to prevent flying substances including flying pieces of concrete from scattering to an outside, by a scatter protecting section which collects and drains the ejected water, and the surface inspection is performed by controlling the ejecting section from the outside of the scatter protecting section.

Accordingly, it is possible to carry out the work while avoiding the flying pieces of concrete and splashes from the water jet. Therefore, a surface inspection which does not cause environmental pollution in a working place can be performed.

According to another aspect of the invention, there is provided a method of repairing concrete comprising removing deteriorated concrete by performing an inspection of a concrete surface using the above method of inspecting a concrete surface; and repairing the portion having the concrete removed.

Accordingly, since the deteriorated concrete is removed when the concrete surface is inspected, basic conditions for the inspection and basic conditions for the removal are the same, and there is no divergence therebetween. Therefore, it is possible to repair the concrete after the deteriorated concrete is reliably removed.

Features and objects of the present invention other than the above will become clear by reading the description of the present specification with reference to the accompanying drawings.

### BRIEF DESCRIPTION OF THE DRAWINGS

For amore complete understanding of the present invention and the advantages thereof, reference is now made to the following description taken in conjunction with the accompanying drawings wherein:

FIGS. 1A and 1B are explanatory views for explaining a structure of a high-pressure water jet ejected into the air;

FIG. 2 is a graph illustrating results of experiment revealing a relationship between the structure of a water jet and the breaking action of the water jet;

FIG. 3 is a graph illustrating a result of the experiment, showing the impact pressure and the magnitude of fluctuation of the impact pressure in the experiment;

FIG. 4 is a graph illustrating a result of frequency analysis of the fluctuation of the impact pressure;

FIG. 5 is a conceptual view for explaining the temporal variation of the impact pressure imposed on a concrete surface by a water jet in a continuous stream region;

FIG. 6 is an explanatory view showing an embodiment of a method of inspecting a concrete surface according to the present invention;

FIGS. 7A and 7B are sectional views, each showing an example of a jet nozzle used in the method of inspecting a concrete surface according to the present invention;

FIG. 8 is a sectional view showing a modification of the method of inspecting a concrete surface according to the present invention;

FIG. 9 is a perspective view of an example of the modification of the method of inspecting a concrete surface according to the present invention; and

FIGS. 10A and 10B are sectional views for explaining an aspect of deterioration of concrete and an example of conventional repair thereof, respectively.

### DETAILED DESCRIPTION OF THE INVENTION

At least the following matters will be made clear by the explanation in the present specification and the description of the accompanying drawings.

Hereinafter, an embodiment of the present invention will be described with reference to the accompanying drawings. Note that description will be given using the same numerals and symbols to designate the same or corresponding members through all the drawings.

First of all, a method of inspecting a concrete surface according to the present invention will be described.

A general method in which a water jet is used for processing, fracturing, washing or the like is called a water jet method (hereinafter, referred to as WJ method). From the viewpoint that a high-pressure water jet has characteristics which have not been utilized in the WJ method as mentioned above, and in an attempt to positively utilize these characteristics, the method of inspecting a concrete surface of the present invention is to use a new deterioration diagnostic technique for concrete, which will replace the tapping test using a hammer. This method is an unprecedented method in which, by utilizing a high-pressure water jet, a deteriorated portion in concrete is found with extreme accuracy, and also is removed simultaneously. This method is an excellent technique which can be said to kill two birds with one stone, so to speak.

In this connection, a description will first be given of the characteristics of a high-pressure water jet, of which the present invention takes advantage.

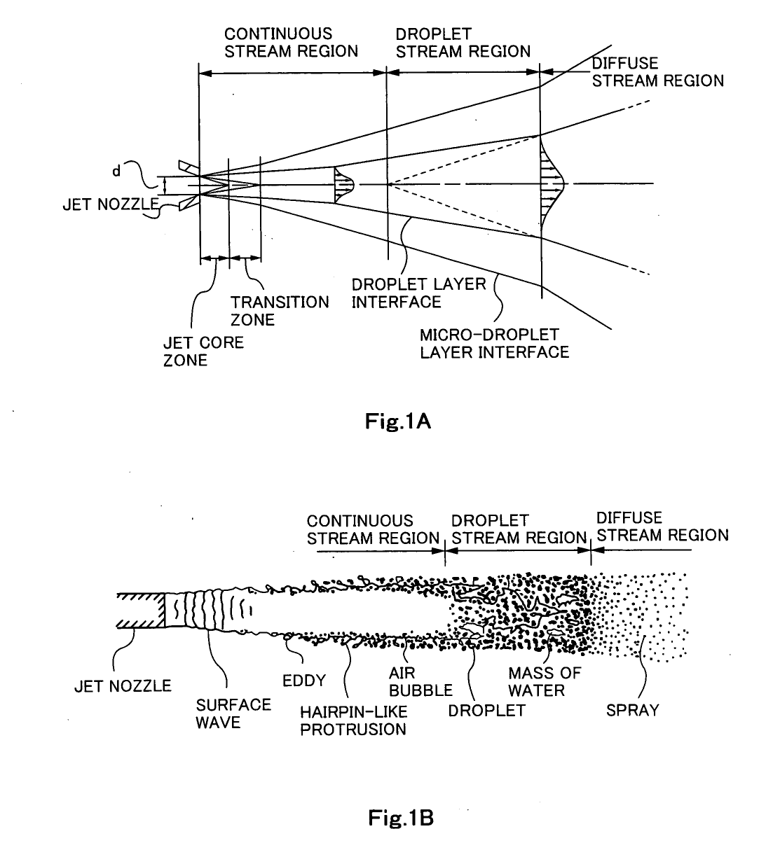

When a high-pressure water jet is discharged at high speed into the air, the high-speed water jet in the air exhibits a structure as shown in FIG. 1A (Yanaida, K., and Ohashi, A. Research on Characteristics of High-Speed Water Jet in the Air Concerning Atomized Droplet Region, the Second Report, Journal of the Mining Institute of Japan, 93-1073 (1977), 489). As shown in this drawing, the high-speed water jet in the air can be broadly classified into three regions: a continuous stream region where the water jet maintains continuity; a droplet stream region where the water jet loses the continuity to generate masses of water and droplets; and a diffuse stream region where the water jet breaks to get in a spray state and diffuses. In the continuous stream region particularly, a transparent portion containing no air which appears in the vicinity of a jet nozzle is called a jet core zone. As the water jet goes downstream, the transparent portion undergoes a transition zone, where air enters the water jet from the periphery thereof, and disappears in the end.

More specifically, as shown in FIG. 1B, a stream of water discharged from the nozzle has a smooth liquid interface immediately after discharged, but surface waves soon appear. The amplitude of the surface waves become gradually larger as the surface waves go downstream. In a downstream portion of the surface waves, the interface is swirlingly drawn inside the water jet to generate unstable eddies. The swirls of crest portions of the surface waves which have become large before long cause hairpin-like protrusions to grow, and allow air to mix into the water jet, forming the disturbed interface containing a large number of air bubbles in the vicinity of the interface. In the droplet stream region located downstream of this, tip portions of the protrusions on the disturbed interface is broken off, becoming very small droplets. At the same time, the breakup gradually proceeds to a central portion of the water jet to cause the water jet to split into masses of water and droplets. These masses of water and droplets further repeat splitting up, and in the diffuse stream region located downstream of this, become fine spray in the end.

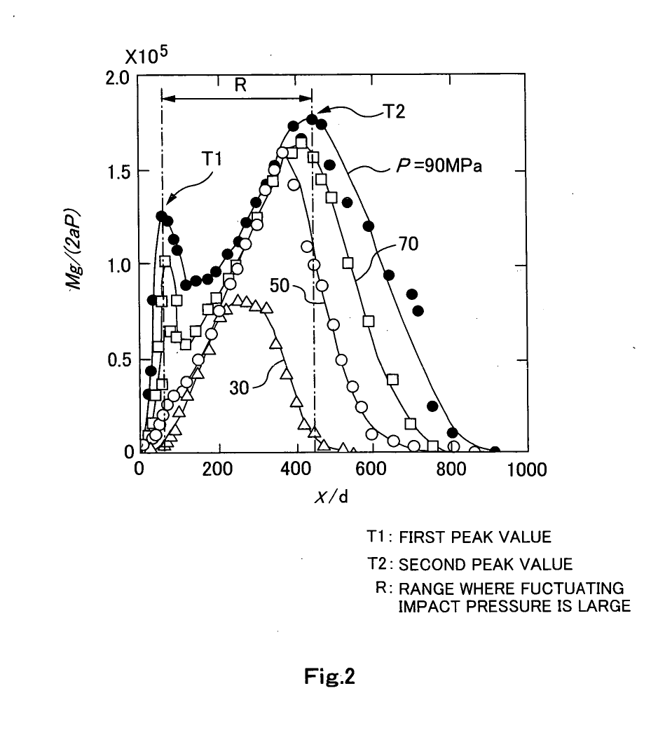

FIG. 2 shows results of experiment which have revealed a relationship between such a structure of a water jet and the breaking action of the water jet. This graph shows results of measuring a relationship that a reduced amount M in mass of a metal material caused by the hit of a high-pressure water jet varies with a distance X between a nozzle outlet and the subject material, in the case of aluminum (Kobayashi, R. Solid Material Processing with High-Speed Water Jet (State of the Art), The Japan Society of Mechanical Engineers Journal Series B, 52-483 (1986), 3645). The diameter of a nozzle outlet (orifice diameter) d is 1 mm, and discharging time is 60 seconds. The reference symbol a denotes the area of the nozzle outlet; g, the acceleration of gravity; and P, the ejection pressure measured upstream of the nozzle. In FIG. 2, the vertical axis represents a value nondimensionalized by dividing a reduced amount M in mass when the ejection pressure P is set to 30 MPa, 50 MPa, 70 MPa, or 90 MPa, by a value equivalent to a kinetic momentum (2 aP) of the water jet. The horizontal axis represents a nondimentinal standoff distance, nondimensionalized by dividing a distance X by a nozzle outlet diameter d.

As can be seen from FIG. 2, when the ejection pressure P is 50 MPa or higher, the reduced amount M in mass hits a first peak T₁ in the vicinity of the nozzle and hits a second peak T₂, which is the maximum, at a position away from the nozzle depending on each of the ejection pressures (in the graph, T₂ indicates the second peak when P=90 MPa). It is generally thought that the excavating action of the water jet is predominant in the vicinity of the first peak and the impact breakage due to the hit of masses of water and droplets is predominant in the vicinity of the second peak.

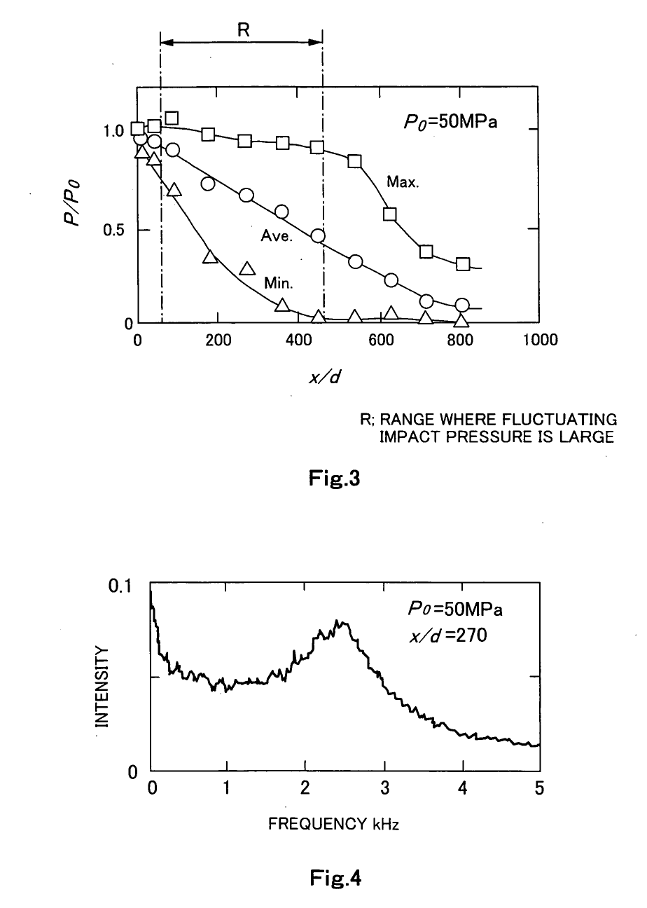

FIGS. 3 and 4 illustrates results of experiments showing that, in the above-described experiment, the material is fractured by a fluctuating impact pressure continuously acting on the water jet (Kobayashi, R., et al. Water Jet Structure and Process of Erosion of Metal Material in Water Jet Processing Technology, The Japan Society of Mechanical Engineers Journal Series B, 52-489 (1987), 1541). In FIG. 3, the vertical axis represents a result value of measurement of the impact pressure P at a position in the central axis of the water jet when the ejection pressure P₀ is 50 MPa. The Max., Ave. and Min. indicate maximum, average, and minimum values, respectively. The horizontal axis represents a nondimensional standoff distance obtained by dividing a distance between the nozzle and a measurement position by a nozzle diameter (orifice diameter) d. Note that a range R sandwiched between the first and second peaks T₁ and T₂ in FIG. 2 is also shown in FIG. 3 for comparison.

It can be seen from FIG. 3 that the impact pressure exhibits characteristics that the maximum impact pressure is substantially constant when the nondimensional standoff distance is in the range R and sharply decreases as the nondimensional standoff distance increases further than the range R, and that the fluctuation width of the impact pressure, which is a difference between the minimum and maximum impact pressures, increases with an increase in the standoff distance in the range R.

FIG. 4 shows a result of performing frequency analysis on the impact pressure at a position around the middle of the range R, where the nondimensional standoff distance x/d is 270, under similar conditions to those in FIG. 3. The horizontal axis represents frequency, and the vertical axis represents spectrum intensity. It can be seen that the spectrum intensity has a local maximum value at about 2.5 kHz. This frequency is two orders of magnitude greater than the fluctuating frequency (about 20 Hz) of the pulsation of a high-pressure pump and is not observed at the jet nozzle and in the downstream zone where the water jet splits up. It is therefore apparent that the frequency has some relationship with the micro-transformation of the water jet and the fluctuation of the impact pressure. However, details of the mechanism thereof have not been uncovered.

In the present invention, concrete is fractured by utilizing the fact that, when the nondimensional standoff distance is set to be in the range R between the first and second peak T_{1 and T}₂ of the impact pressure, a high-pressure water jet takes on a structure that is of the continuous stream region and close to the droplet stream region, and accordingly the impact pressure becomes high and the fluctuation width thereof becomes large.

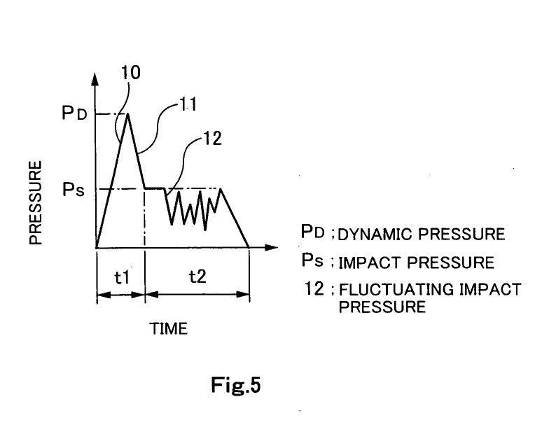

FIG. 5 is a conceptual view showing variation in the pressure at the time of hitting when such a high-pressure water jet is ejected at a concrete surface. The horizontal axis represents time, and the vertical axis represents the pressure. A line 10 shows that the front end of the water jet first starts contacting the concrete surface at the origin, and then the pressure applied to the concrete surface increases to reach a maximum pressure (dynamic pressure) P_{D}. A line 11 shows that the pressure decreases because the water jet transformed into masses of water hits the concrete surface and thereby spreads thereon. Time t₁, a period between these events, is thought to be extremely short. A polygonal line 12 thereafter in time t₂ shows that micro-masses of water of the subsequent jet water continuously reach the concrete surface and generates high-frequency fluctuating pressure.

When such a high-pressure water jet is ejected to deteriorated concrete, first, the water jet is allowed to penetrate into the concrete by the high pressure, through fine pores on the surface of the concrete. At this time, if a fault such as cracking is present in the concrete, the water jet naturally concentrates in the fault and penetrates therein. When water has permeated the concrete, the water permeating inside the concrete has no way to escape, and accordingly constitutes closed conduit lines as a whole. Thus, the pressure on the concrete surface is transmitted to the inside of the concrete. The pressure at this time is high-frequency fluctuating impact pressure, as described above. Therefore, the concrete receives repetitive loads with large fluctuation widths. Accordingly, micro-fracture of fine concrete composition advances thereby extending the fault. Since a tip of a crack such as cracking particularly receives internal pressure which serves as a tensile load, the crack acceleratedly grows.

Such an effect is not produced in the region of the nondimensional standoff distance on the jet nozzle side of the first peak T₁. In this region, the excavating action is predominant, so the concrete receives continuous high pressure uniformly. Therefore, the concrete composition is broken from the concrete surface before the water jet has penetrated into the concrete. Thus, the fracture advances regardless of the presence of a fault.

In addition, such an effect is not produced either in the region of the nondimensional standoff distance, on the downstream side of the second peak T₂. In this region, the maximum value of the impact pressure has decreased, and the continuity of the water jet is completely lost. Therefore, even if the water jet penetrates into the concrete, high pressure to fracture the concrete is not maintained.

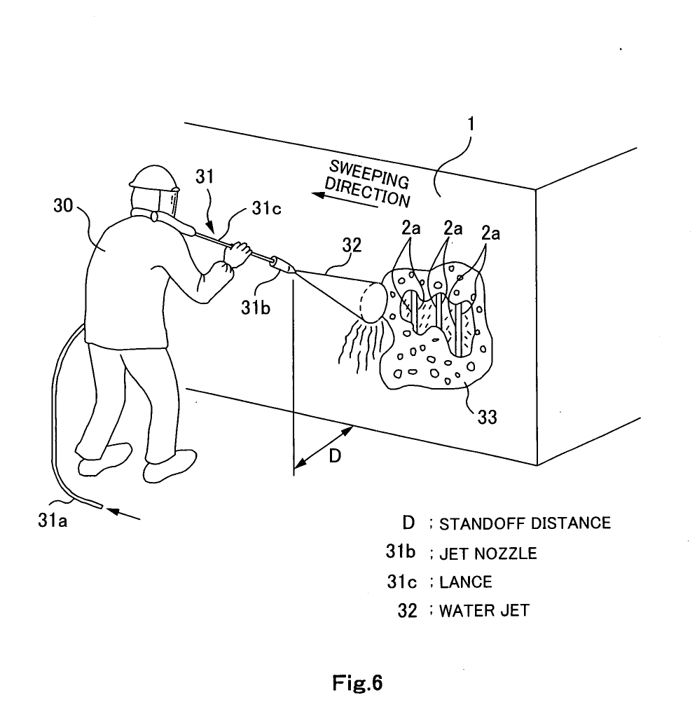

Hereinafter, a detailed description will be given of a method of inspecting a concrete surface according to the present invention, which utilizes the above-described principle. FIG. 6 is a view schematically showing that a worker 30 is performing the method of inspecting a concrete surface according to the present invention on a concrete structure 1.

In order to effectively fracture deteriorated concrete, the worker 30 holds a hand gun 31 ejecting jet water 32 and, keeping a standoff distance D from the concrete surface, sweeps the jet water 32 in the lateral direction while repeatedly moving the hand gun 31 up and down. The hand gun 31 is supplied with highly pressurized water of which the water pressure, the water amount and the like are adjusted beforehand, from a high-pressure water tube 31a at the back of the worker 30 and, via lance 31c, discharges jet water 32 as a high-pressure water jet with a jet nozzle 31b provided on the tip of the lance 31c. As a result, the deteriorated concrete having a fault inside is spalled off, and a sound concrete face 33 and reinforcing steel 2a are exposed.

The high-pressure water tube 31a is connected to a high-pressure pump (not shown) for supplying the highly pressurized water. As the high-pressure pump, any of various pumps can be used. For example, a plunger pump using a crank, which produces large pulses, can be employed.

As the jet nozzle 31b, any jet nozzle can be employed if it is able to implement the aforementioned water jet structure of the continuous stream region. However, the use of a jet nozzle capable of rotating so as to draw a conical orbit while maintaining the water jet structure can prevent omission in the inspection and shorten time required for the sweeping because a wide area can be swept. Therefore, this type of jet nozzle is very suitable. For example, an orbital jet nozzle and a rotary jet nozzle are examples of such a jet nozzle.

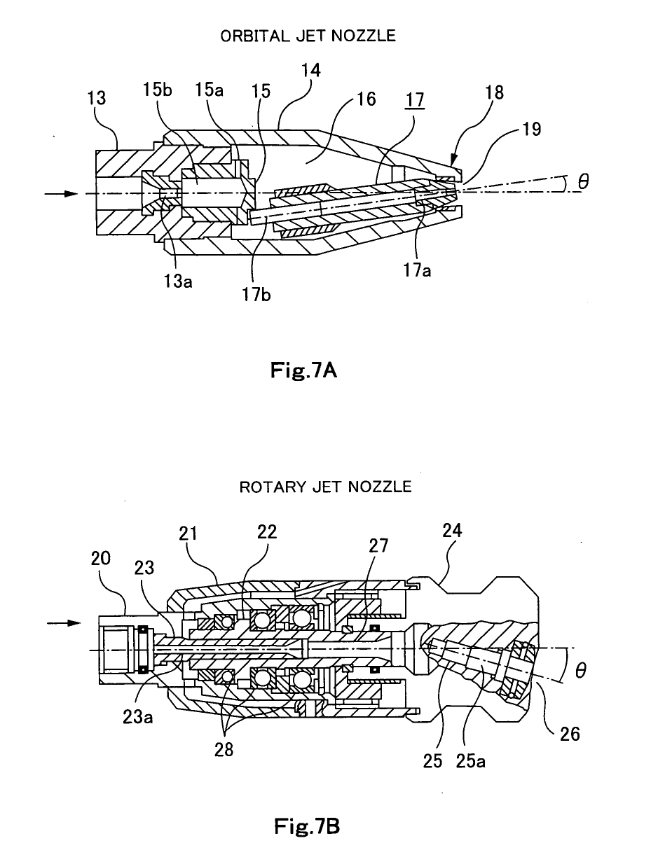

Respective structures of these nozzles will be described with reference to FIGS. 7A and 7B.

In an orbital jet nozzle shown in FIG. 7A, a front chamber 16 for maintaining highly pressurized water is formed by closing the rear end of a pressure casing 14 having an opening 19 at the front end thereof with a stop cock tube 13 provided therein with a conduit line. Inside the front chamber 16, provided are a turbulence forming tube 15 having a jet outlet 15a for changing the direction of the highly pressurized water introduced from the stop cock tube 13 by about 90°, and a rotor 17 rotatable with an orifice section 17a thereof engaging with a rotor pedestal 18. The rotor 17 is provided with a nozzle conduit line 17b with an extended inlet conduit for forming the continuous stream region.

According to such a configuration, the highly pressurized water, which is introduced from the left side of the drawing, is injected into the front chamber 16 after the flow path thereof is bent about 90° through the turbulence forming tube 15. Accordingly, high-pressure rotating turbulence occurs in the front chamber 16, rotating the rotor 17 in one direction. At this time, since the orifice section 17a on the front end of the rotor 17 is engaging with the rotor pedestal 18, the rear end of the rotor 17 rotates along the inner wall of the pressure casing 14. The entire rotor 17, tilting from the central axis at an angle θ, draws a rotational orbit of a conical shape. Meanwhile, the highly pressurized water passes through the nozzle conduit line 17b and the orifice portion 17a, and then is ejected from the opening 19 to the outside. Since the nozzle conduit line 17b serves as an inlet conduit, where the turbulence is made laminar to some extent, the ejection water jet does not break immediately. Accordingly, the emission and scatter of the water jet is relatively little. The water jet therefore having high power makes circular rotations on the concrete surface while drawing a conical orbit surface.

At this time, making the center of the jet nozzle coincide with the normal line of the concrete surface will allow the angle θ to be the incident angle of the water jet. If the incident angle is large, an amount of water reflected from the concrete surface becomes large, resulting in an amount of the water jet penetrating into the concrete being reduced. Therefore, the angle θ is preferably set at 30° or less, more preferably at about 10°.

Next, a rotary jet nozzle shown in FIG. 7B is a jet nozzle in which a housing 20, having a hole for introducing highly pressurized water on the left side of the drawing and having bearings 28 arranged by extending a tube shape coaxial with the hole on the right side of the drawing, is provided with a fixed shaft 23, a rotary shaft 22, a rotor 24, and the like.

The fixed shaft 23 is constituted by a tubular member having a conduit line 23a in its axial center, and is fixed coaxially with the central axis of the housing 20. The rotary shaft 22 is constituted by a tubular member having a conduit line 27 in its axial center. An outside diameter portion of the rotary shaft 22 is rotatably supported by the bearings 28 arranged on the rotary shaft 22, and an inside diameter portion thereof is rotatable fitted on an outside diameter portion of the fixed shaft 23. Further, the rotor 24 is fixed onto the front end of the rotary shaft 22 on the right side of the figure. The rotary shaft 22 is a rotator thus configured.

The rotor 24 has a conduit line (not shown) branching in a T shape, on an extended line of the conduit line 27. On the end of each branch conduit line, as shown in the drawing, an oblique conduit line 25 tilted from the central axis at an angle θ is provided. The oblique conduit lines 25 are tilted in the opposite directions so as to be in a twist positional relationship (in the figure, a section of only one of the oblique conduit lines 25 is shown). Each of the oblique conduit lines 25 has an opening 26 at the front end thereof and a jet nozzle 25a having an orifice is provided midway along it.

According to such a configuration, highly pressurized water introduced from the housing 20 passes through the conduit lines 23a and 27, the oblique conduit lines 25, and the jet nozzles 25a, and is then discharged from the openings 26 to the outside. The water jets are on different planes from each other and made to form a relative angle of 2θ with each other. Accordingly, a rotation moment occurs on the rotor 24, and the rotor 24 rotatable is rotated. As a result, the water jets rotate on a conical orbit surface.

Hence, it is possible to obtain a high-pressure water stream rotating similarly to that of the orbital jet nozzle. However, the structure of the rotary jet nozzle is complicated. Therefore, for example, the length of the oblique conduit lines 25 cannot be secured sufficiently, which causes the necessity of making the angle θ relatively large in order to increase rotary force. Accordingly, the water jet power is slightly lower than that of the orbital jet nozzle.

Next, a description will be given of conditions for a water jet used in the present invention. Parameters to be set as the conditions include the standoff distance D, the ejection water pressure P, the ejection water amount Q, the orifice diameter d of the jet nozzle, and the traveling speed V of the water jet.

In the present invention, first, the nondimensional standoff distance D/d, obtained by dividing the standoff distance D by the orifice diameter d of the jet nozzle, is determined so as to satisfy the relationship 100≦(D/d)≦500. For example, when the orifice diameter d is equal to 1 mm, the standoff distance D is equal to 100 to 500 mm.

Next, the ejection water pressure P and ejection water amount Q required for fracture are determined depending on the degree of the deterioration of deteriorated concrete. If the well-known Bernoulli equation is used, the ejection water amount Q can be determined by simple calculation using the orifice diameter d and the ejection water pressure P as follows. Here, note that F is nozzle efficiency (for example, about 0.92) according to the shape of the jet nozzle.

Q=d²×\sqrt{P}×0.659×F

where Q is the ejection water amount (1/min), P is the ejection water pressure (bar), F is the nozzle efficiency (0.92 to 0.95), and d is the orifice diameter (mm).

According to the aforementioned principle of the fracture of deteriorated concrete, impact pressure to perform micro-fracture of a deteriorated concrete composition is required while securing a water amount enough to allow a water jet to penetrate into concrete. Referring to FIG. 3, it can be seen that the maximum values Max. of the impact pressure are substantially equal to the ejection water pressure P (in FIG. 3, the ejection pressure P₀) over the range R. However, since this impact pressure acts on the concrete in the closed conduit line state, where water has permeated the concrete, water hammer force is also generated. In addition, different concrete structures adopt different concrete strengths, and the states of deterioration advancement and the causes of deterioration further widely vary with the individual concrete structures. Accordingly, it is difficult in the current situation to logically determine required quantities such as the water amount and the ejection water pressure. Therefore, in practice, it is necessary to set the various conditions by performing preliminary tests on specific deteriorated concrete.

If a generalization is made about experiments hitherto performed by the inventor, the generalization is that a suitable ejection water pressure P and a suitable ejection water amount Q according to the present invention to fracture deteriorated concrete of a normal concrete structure are 50 to 80 MPa and 20 to 50 liter/min, respectively. Experience shows that, when fracture tests are performed on sample deteriorated concrete while changing the ejection water pressure P and the orifice diameter d such that P and d are within the above-mentioned respective ranges, it is possible to efficiently determine conditions for fracturing only deteriorated concrete while leaving sound concrete.

Note that, as a matter of course, there are suitable parameter values outside the above-mentioned ranges, for different types of concrete from normal concrete, including high-strength concrete, an old concrete architectural structure such as, for example, a historic structure, concrete in which deterioration has advanced to an extreme degree due to, for example, alkali-aggregate reaction or the like, etc. It is needless to say that the parameter values outside the above-mentioned ranges can be adopted as well.

Next, the traveling speed V of a water jet is a parameter that determines time until fracture and is in relation to working time. That is, even if the other parameters are suitably selected, making the traveling speed V large in a practical inspection will allow the water jet to pass through a portion which should be fractured originally, without fracturing the portion. Therefore, it is necessary to determine a traveling speed V at the time of working beforehand by changing the traveling speed V in the preliminary tests. The findings of the inventor suggest that a generally suitable traveling speed V is about 15 to 20 sec/m, for example.

As described above, according to the present invention, a practical standoff distance is determined based on the nondimensional standoff distance, which is in a range of the continuous stream region between the first and second peaks T₁ and T₂ in FIG. 2, where the fluctuation of the impact pressure is large. Accordingly, it is possible to use a jet stream region suitable to fracture deteriorated concrete, and thus to fracture deteriorated concrete by means of the WJ method using the parameters which are preset as the conditions for fracturing only deteriorated concrete. Therefore, it is possible to perform an objective inspection for fracture by keeping the parameters constant, and simultaneously to fracture deteriorated concrete while leaving sound concrete.

In addition, the conditions concerning the surface inspection relies to an extremely small degree on the working technique of the worker 30 who operates the hand gun 31. Accordingly, a low-skilled worker can be employed as the worker 30.

Next, a description will be given of a modification of the method of inspecting a concrete surface according to the present invention.

In the foregoing example, the description has been given on the assumption that the worker 30 performs a surface inspection. That is, a conventional hammer is replaced by the hand gun 31 using the WJ method, and thus the objectivity of inspection is remarkably enhanced.

However, in a case of a concrete structure such as a road bridge or a railroad tunnel for example, an inspection area is enormous. In addition, there are constrains of working time. Therefore, it is desired to use a mechanized inspection method. Although the mechanization of an inspection method was difficult with the conventional tapping test using a hammer, the mechanization thereof is feasible according to the present invention.

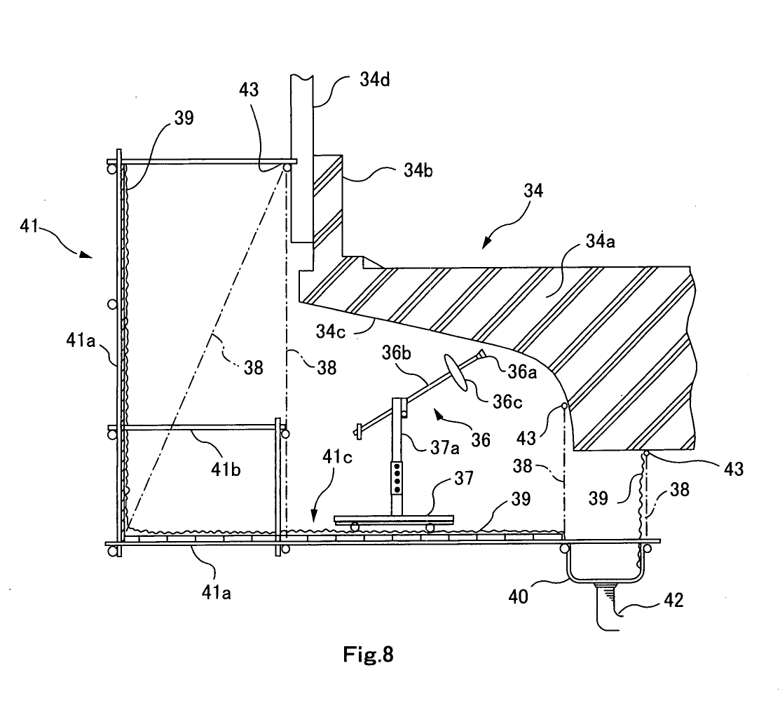

FIG. 8 shows a sectional view for explaining the modification according to the present invention. The symbol 34 denotes a concrete bridge being subject to a surface inspection. The concrete bridge 34 includes, for example, a bridge girder 34a, a bridge side section 34b, and the like, and is provided with belongings (optical cables, conduit tubes, and the like) near a strut 34d and an overhanging floor slab lower face 34c. The vicinities of these belongings are very difficult places to work on. The use of highly pressurized water will enable the work to be carried out without any problems. The state shown in the drawing is where the overhanging floor slab lower face 34c of the bridge girder 34a is being inspected.

Scaffolding is built by the concrete bridge 34, on a grid formation with frames 41b such as steel pipes, and is detachably supported by the concrete bridge 34 with chains 38 or the like in such a manner that, for example, pieces of supporting hardware 43 are disposed on the concrete bridge 34 and the chains 38 or the like are extended therefrom. Guard panels 41a made up of board members such as, for example, concrete panels are fixed between the frames 41b, thus constituting a scatter protecting framework 41 by which an inspection face such as the overhanging floor slab lower face 34c is covered so as to be surrounded. A waterproof protective sheet 39 is laid all over the inner faces of the scatter protecting frame work 41. A drain 40 for collecting splashes of water inside the scatter protecting frame work 41 is provided in a lower floor face 41c of the scatter protecting frame work 41. A drain conduit line 42 for draining the collected water away to the outside is provided on the lower face of the drain 40. The lower floor face 41c is flat and allows a high-pressure water jet apparatus 36 provided with moving wheels to run along the lower floor face 41c.

The high-pressure water jet apparatus 36, placed on the lower floor face 41c, is an apparatus including a moving section 37 movable by remote control, a supporting column 37a on the moving section 37, a water conduit arm 36b provided, on its tip, with a jet nozzle 36a for discharging highly pressurized water. The water conduit arm 36b combines a supporter of the jet nozzle 36a and a distributing pipe for the highly pressurized water, and is made capable of changing the direction of the jet nozzle 36a by remote control. In a middle portion of the water conduit arm 36b, a guard plate 36c is provided for guarding the high-pressure water jet apparatus 36 from reflected water and splashes from the water jet and flying pieces of broken concrete. Note that, although not shown, a high-pressure pump for supplying highly pressurized water to the water conduit arm 36b, and a control device for controlling the movement and motion of the moving section 37 and the water conduit arm 36b are individually connected to the high-pressure water jet apparatus 36 and placed outside the scatter protecting frame work 41.

According to the configuration as described above, a water jet, the conditions of which is fixed, can be ejected to an inspection face by remote control, at a predetermined jet nozzle moving rate and sweeping rate, while maintaining a constant distance between the jet nozzle 36a and the inspection face. As for the remote control, a moving path according to a positional relationship with the inspection face may be planned and inputted as control data in advance. Alternatively, for example, a television camera may be mounted on the high-pressure water jet apparatus 36 or the like, and the apparatus maybe operated while the inspection face is remotely observed. When the sweeping is completed for a predetermined segment to finish the inspection, the scatter protecting frame work 41 is disassembled and then moved to a next inspection segment.

As described above, according to this modification, it is possible to perform an extremely objective inspection on a concrete surface not by human hands. Since little manpower is required, it is possible to reduce the percentage of labor costs in inspection costs. Further, it is possible to perform an inspection without impairing safety even in a bad inspection environment, for example, such as under the overhanging floor slab lower face 34c, where splashes of water and pieces of broken concrete fall from above.

Moreover, since the water splashes from a water jet and the pieces of broken concrete do not scatter to the outside of the scatter protecting frame work 41, this modification has an excellent effect of not causing environmental pollution around an inspection place.

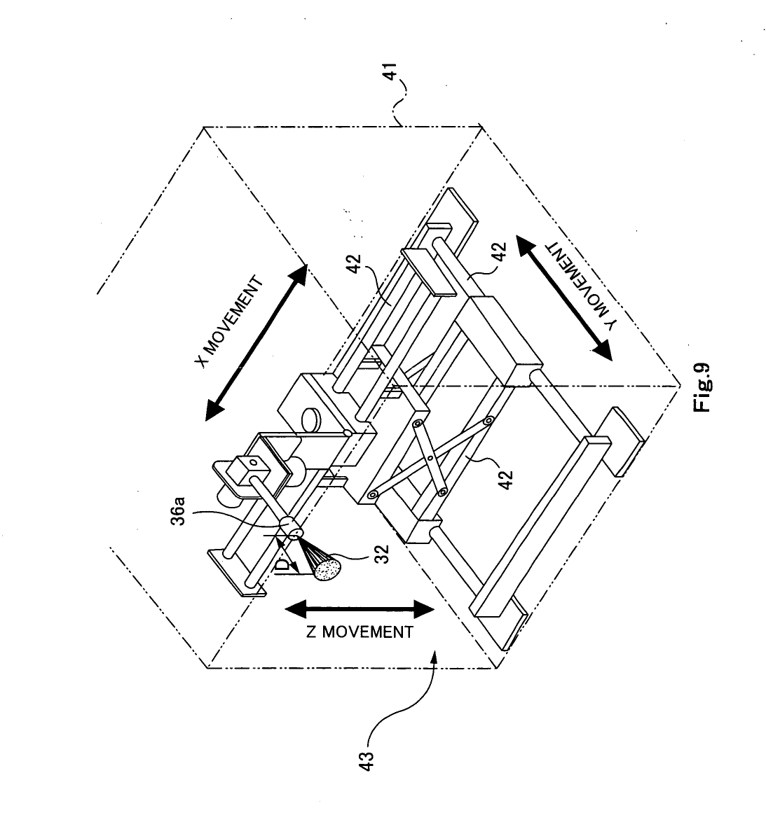

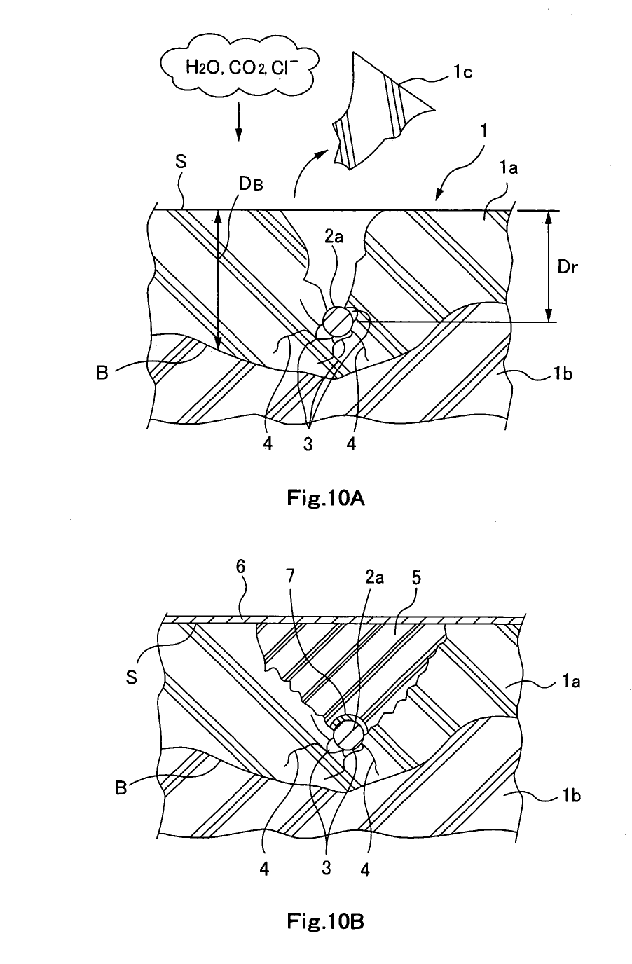

Note that, although the example where the subject of inspection is a concrete structure of a complicated shape such as the bridge girder 34a, has been discussed in the above description, it is not necessary to set up the scatter protecting frame work 41 on such a large scale if the subject of inspection is simply a flat wall body or a flat ceiling. For example, as shown in FIG. 9, a construction may be employed which is in a shape of a relatively small box open to an inspection face, and the moving section 42 such as a slide rail, and a discharging section which is fixed to the moving section 42 and is capable of scanning a plane within an opening 43, may be provided inside the construction. Such a configuration will enable the inspection place to be changed conveniently by moving the entire scatter protecting frame work 41 by, for example, a lifter. Accordingly, the surface inspecting method will have great flexibility.

Next, a method of repairing a concrete surface according to the present invention will be described.

In the method of repairing a concrete surface according to the present invention, a surface inspection is first performed by the above-described method of inspecting a concrete surface according to the present invention. When the inspection is completed, deteriorated concrete has been fractured, and a sound concrete surface and reinforcing steel are exposed. At this time, since the exposed sound concrete surface and reinforcing steel have been subjected to a high-pressure water jet, the sound concrete surface and reinforcing steel are normally in a sufficiently cleaned state. However, in some cases, a blasting treatment and/or a cleaning treatment may be performed by the normal WJ method in order to prepare the face for contact with repair concrete. Subsequently, the repair concrete is poured into a fractured portion. A method of pouring concrete may be any of methods which are normally adopted (for example, trowel finish, shotcrete, etc.). A rust inhibitor may be applied to the reinforcing steel prior to the pouring of concrete.

According to such a repairing method, deteriorated concrete is reliably removed before repair concrete is poured, and the exposed sound concrete surface has no occurrence of micro-cracks and is good at fitting (bonding) the repair concrete. Accordingly, the repairing method has extremely high reliability.

As described above, according to one aspect of the invention, concrete is fractured by a jet stream of highly pressurized water permeating through a pore structure and cracks in deteriorated concrete thereby advancing fracture. Accordingly, sound concrete having no such faults will not be fractured. As a result, this invention will be a rational and objective surface inspecting method with which sound concrete is left not fractured. At the same time, this invention will bring an advantage of suppressing an amount of poured repair material required for repair, and repair costs.

According to another aspect of the invention, conditions for concrete fracture are kept constant by maintaining constant conditions of ejecting highly pressurized water and a constant standoff distance. Accordingly, it is possible to preserve the reproducibility of inspection conditions, and to fracture and spall off the concrete which is determined to be deteriorated concrete under the objective inspection conditions. As a result, an objective inspection will be feasible, bringing an advantage of preventing an omission in the inspection and/or an excess of inspection which would otherwise be caused by an error of subjective judgment.

In addition, since a concrete surface is swept by a water jet in a manner as described above, the inspection can be performed without omission. Accordingly, this invention has an advantage of being a highly reliable inspecting method.

According to yet another aspect of the invention, a jet stream region where impact pressure and fluctuation thereof markedly occur is adopted for a high-pressure water jet. Accordingly, the high-pressure water jet penetrates into a pore structure and cracking portions in concrete, which are faults in a concrete composition, and accelerates breakage from the faults to fracture the concrete. Thus, sound concrete can be left reliably. As a result, this invention will be a rational and objective surface inspecting method by which sound concrete is not fractured. At the same time, this invention will bring an advantage of suppressing an amount of poured repair material required for repair, and repair costs.

According to still another aspect of the invention, the conditions are narrowed into the ranges in which the continuous stream region of a high-pressure water jet hits the concrete surface. Accordingly, it becomes easy to examine a suitable high-pressure water jet for use in the method of inspecting a surface of deteriorated concrete. As a result, this invention will bring an advantage of reducing the work in a surface inspection.

According to yet another aspect of the invention, it is possible to eject a water jet over a wide area while suitably maintaining the properties of the high-pressure water jet. Accordingly, sweeping work is facilitated, and a thorough inspection becomes feasible. Therefore, it becomes possible to speedily perform the inspection without omission. As a result, this invention will bring an advantage of performing an objective and highly reliable inspection.

According to another aspect of the invention, it is possible to carry out the work while avoiding flying pieces of concrete and splashes from a water jet. Accordingly, a surface inspection which does not cause environmental pollution in a working place can be performed. As a result, this invention will bring an advantage of performing a safe surface inspection with high working efficiency.

According to yet another aspect of the invention, a concrete surface is inspected, and simultaneously deteriorated concrete is removed. Accordingly, basic conditions for the inspection and basic conditions for the removal are the same, and there is no divergence therebetween. Therefore, it is possible to repair concrete after deteriorated concrete is reliably removed. As a result, this invention will bring an advantage of improving the reliability of the repair.

Although the preferred embodiment of the present invention has been described in detail, it should be understood that various changes, substitutions and alterations can be made therein without departing from spirit and scope of the inventions as defined by the appended claims.

1. A method of inspecting a concrete surface, the method comprising:
ejecting highly pressurized water to a concrete surface by using a jet nozzle, thereby fracturing and spalling off deteriorated concrete deteriorated in strength, with leaving only sound concrete, for inspection of surface strength.

2. The method of inspecting a concrete surface according to claim 1, wherein said concrete surface is swept by a water jet while ejection conditions for ejecting said highly pressurized water and a standoff distance are kept constant, said standoff distance being a distance between said jet nozzle and said concrete surface.

3. The method of inspecting a concrete surface according to claim 1, wherein said standoff distance is set so that a high-pressure water jet to be ejected to said concrete surface is in a continuous stream region located downstream of a transition zone.

4. The method of inspecting a concrete surface according to claim 3, wherein conditions of said high-pressure water jet are set to be in ranges of:
ejection water pressure of 50 to 80 MPa;
ejection water amount of 20 to 50 liter/min; and
nondimensional standoff distance of 100 to 500, the nondimensional standoff distance being obtained by dividing said standoff distance by an orifice diameter d of the jet nozzle.

5. The method of inspecting a concrete surface according to claim 1, wherein said jet nozzle is used in a manner that said jet nozzle is put into rotational motion and thereby causes said high-pressure water jet to draw a conical orbit.

6. The method of inspecting a concrete surface according to claim 1, wherein the concrete surface to undergo the surface inspection and an ejecting section for ejecting said highly pressurized water are both covered to prevent flying substances including flying pieces of concrete from scattering to an outside, by a scatter protecting section which collects and drains the ejected water, and the surface inspection is performed by controlling said ejecting section from the outside of said scatter protecting section.

7. A method of repairing concrete, the method comprising:
removing deteriorated concrete by performing an inspection of a concrete surface using the method of inspecting a concrete surface according to claim 1; and
repairing the portion having the concrete removed.

8. The method of inspecting a concrete surface according to claim 2, wherein said standoff distance is set so that a high-pressure water jet to be ejected to said concrete surface is in a continuous stream region located downstream of a transition zone.

9. The method of inspecting a concrete surface according to claim 2, wherein said jet nozzle is used in a manner that said jet nozzle is put into rotational motion and thereby causes said high-pressure water jet to draw a conical orbit.

10. The method of inspecting a concrete surface according to claim 3, wherein said jet nozzle is used in a manner that said jet nozzle is put into rotational motion and thereby causes said high-pressure water jet to draw a conical orbit.

11. The method of inspecting a concrete surface according to claim 4, wherein said jet nozzle is used in a manner that said jet nozzle is put into rotational motion and thereby causes said high-pressure water jet to draw a conical orbit.

12. The method of inspecting a concrete surface according to claim 2, wherein the concrete surface to undergo the surface inspection and an ejecting section for ejecting said highly pressurized water are both covered to prevent flying substances including flying pieces of concrete from scattering to an outside, by a scatter protecting section which collects and drains the ejected water, and the surface inspection is performed by controlling said ejecting section from the outside of said scatter protecting section.

13. The method of inspecting a concrete surface according to claim 3, wherein the concrete surface to undergo the surface inspection and an ejecting section for ejecting said highly pressurized water are both covered to prevent flying substances including flying pieces of concrete from scattering to an outside, by a scatter protecting section which collects and drains the ejected water, and the surface inspection is performed by controlling said ejecting section from the outside of said scatter protecting section.

14. The method of inspecting a concrete surface according to claim 4, wherein the concrete surface to undergo the surface inspection and an ejecting section for ejecting said highly pressurized water are both covered to prevent flying substances including flying pieces of concrete from scattering to an outside, by a scatter protecting section which collects and drains the ejected water, and the surface inspection is performed by controlling said ejecting section from the outside of said scatter protecting section.

15. The method of inspecting a concrete surface according to claim 5, wherein the concrete surface to undergo the surface inspection and an ejecting section for ejecting said highly pressurized water are both covered to prevent flying substances including flying pieces of concrete from scattering to an outside, by a scatter protecting section which collects and drains the ejected water, and the surface inspection is performed by controlling said ejecting section from the outside of said scatter protecting section.

16. A method of repairing concrete, the method comprising:
removing deteriorated concrete by performing an inspection of a concrete surface using the method of inspecting a concrete surface according to claim 2; and
repairing the portion having the concrete removed.

17. A method of repairing concrete, the method comprising:
removing deteriorated concrete by performing an inspection of a concrete surface using the method of inspecting a concrete surface according to claim 3; and
repairing the portion having the concrete removed.

18. A method of repairing concrete, the method comprising:
removing deteriorated concrete by performing an inspection of a concrete surface using the method of inspecting a concrete surface according to claim 4; and
repairing the portion having the concrete removed.

19. A method of repairing concrete, the method comprising:
removing deteriorated concrete by performing an inspection of a concrete surface using the method of inspecting a concrete surface according to claim 5; and
repairing the portion having the concrete removed.

20. A method of repairing concrete, the method comprising:
removing deteriorated concrete by performing an inspection of a concrete surface using the method of inspecting a concrete surface according to claim 6; and
repairing the portion having the concrete removed.
